(19) United States
(12) Patent Application Publication
(10) Pub. No.: US 2014/0047943 A1
(43) Pub. Date: Feb. 20, 2014

(54) HOUSEHOLD APPLIANCE COMPRISING A KNOB WHICH OPERATES SILENTLY

(71) Applicants: Ugur Camli, Istanbul (TR); Mehmet Baris Gocer, Istanbul (TR)

(72) Inventors: Ugur Camli, Istanbul (TR); Mehmet Baris Gocer, Istanbul (TR)

(21) Appl. No.: 13/977,714

(22) PCT Filed: Dec. 14, 2011
(86) PCT No.: PCT/EP11/72741

§ 371 Date: Nov. 5, 2013

(30) Foreign Application Priority Data
Dec. 30, 2010 (TR) A 2010/11187

(51) Int. Cl. G05G 1/10

(52) U.S. Cl. CPC G05G 1/10
USPC 74/553

(57) ABSTRACT

The present invention relates to a household appliance (1) comprising a control panel (4) that has a front plate (2) and a rear plate (3) adjacent to each other placed one in front of the other, a knob hole (5) that is located on the control panel (4), a retractable and rotary knob (6) that moves inside the knob hole (5) and a bearing (7) that is disposed into the knob hole (5) and supports the knob (6) so that the knob (6) slidably move therein by surrounding the knob (6), and wherein the knob (6) is provided to operate silently inside the bearing (7).

The present invention relates to a household appliance comprising a knob which is located on the control panel.

On the control panel of household appliances, for instance cooking devices, retractable and rotary knobs providing the household appliance to be operated or the programs to be adjusted are widely used. During the use of the knob, the forces applied by the user cause the knob to rub against or hit the housing wherein the knob is operated in the control panel and therefore the bearing, wherein the knob is operated, is abraded and the generated noise disturbs the user. In the state of the art, in order that the knob operates silently, the periphery of the knob body is covered with an elastic material; however, this solution requires modifications to be performed on the knob design and the noisy operation of the knob cannot be prevented.

In the state of the art Chinese Patent Document No. CN101694591, a button is explained wherein the handfeel is improved and sound transmission is reduced. The button body is covered with an elastic material.

The aim of the present invention is the realization of a household appliance comprising a knob which is located on the control panel and provided operate silently.

On the control panel of the household appliance realized in order to attain the aim of the present invention and explicated in the claims, at least one retractable and rotary knob is located and the control panel consists of a front plate and a rear plate adjacent to each placed one in front of the other. A damping member surrounding the knob hole is disposed between the front plate and the rear plate at the area around the knob hole on the control panel.

In an embodiment of the present invention, the damping member is a flat rubber ring and is disposed to the control panel by being pressed between the front plate and the rear plate.

In another embodiment of the present invention, the damping member is a silicon adhesive adhering the front plate and the rear plate.

In another embodiment of the present invention, the front plate is produced from thin metal and the rear plate from glass thicker than the front plate.

In the household appliance, the knob is provided to operate silently without changing the knob structure by means of a damping member disposed between two plates.

The household appliance realized in order to attain the aim of the present invention is illustrated in the attached figures, where:

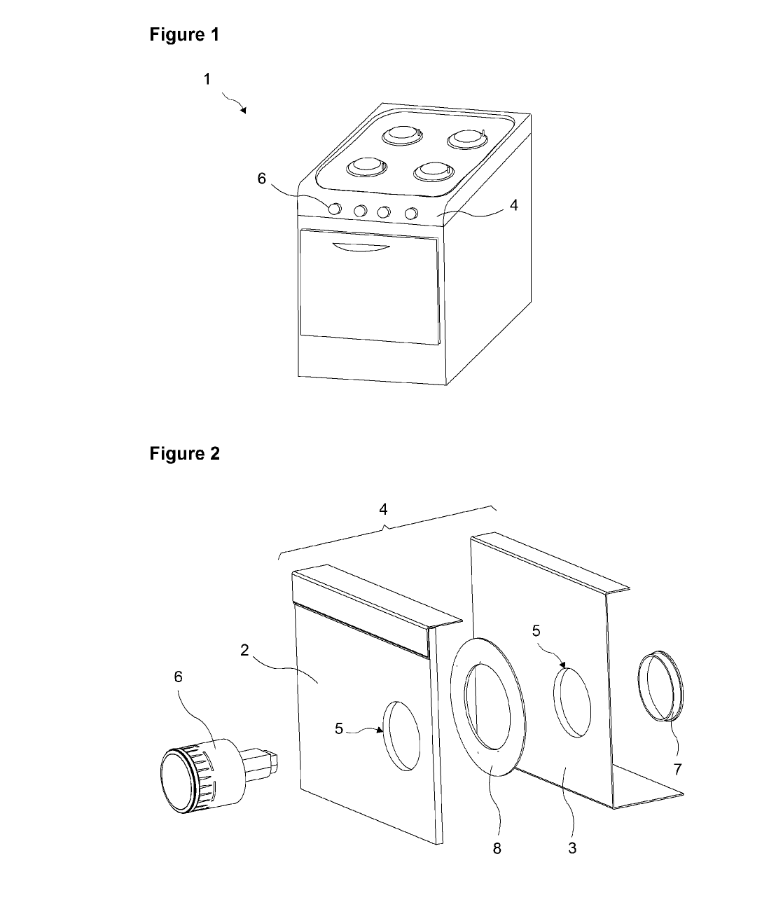

FIG. 1—is the perspective view of a household appliance.

FIG. 2—is the exploded view of a knob, a control panel, a damping member and a bearing.

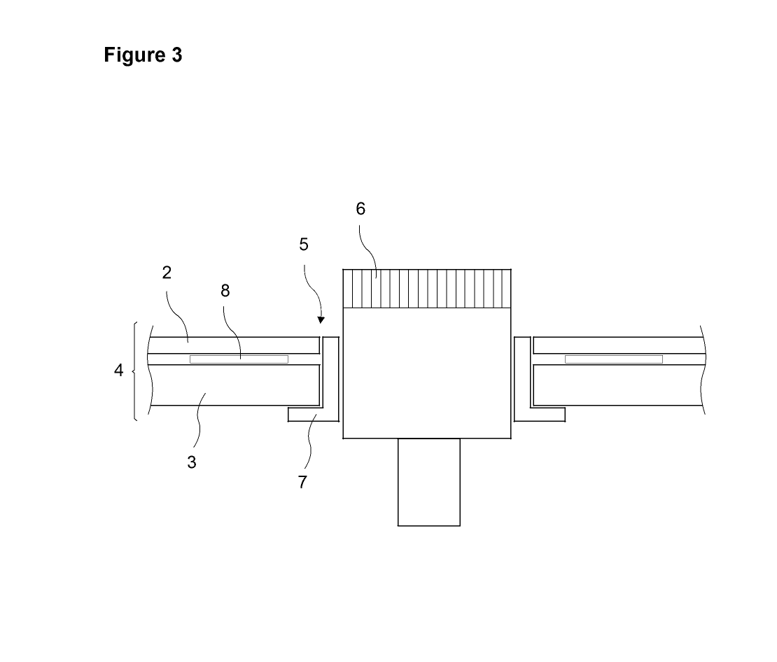

FIG. 3—is the schematic view of a knob, a control panel, a damping member and a bearing.

The elements illustrated in the figures are numbered as follows:
1. Household appliance
2. Front plate
3. Rear plate
4. Control panel
5. Knob hole
6. Knob
7. Bearing
8. Damping member

The household appliance (1) comprises a control panel (4) which has a front plate (2) and a rear plate (3) adjacent to each placed one in front of the other, a knob hole (5) which is located on the control panel (4), a retractable and rotary knob (6) which moves inside the knob hole (5) and a bearing (7) which is disposed into the knob hole (5) and which supports the knob (6) so that the knob (6) slidably move therein by surrounding the knob (6).

The household appliance (1) of the present invention comprises an elastic damping member (8) which is disposed between the front plate (2) and the rear plate (3) at the control panel (4) area around the knob hole (5) and which surrounds the knob hole (5) and therefore the bearing (7), and provides the front plate (2) to spring on the rear plate (3) around the knob hole (5).

In order to operate the household appliance (1) or adjust the programs, the user applies forces onto the knob (6) in the axial direction or in the direction of rotation. When the knob (6) is pressed in an unbalanced manner, the knob (6) hits the bearing (7) or rubs against it. The forces applied from the knob (6) to the bearing (7) are transmitted from the bearing (7) to the front plate (2) in the radial direction and from the front plate (2) to the rear plate (3) in the axial direction. The damping member (8) damps the forces transmitted from the front plate (2) to the rear plate (3). By increasing the toughness of the bearing (7), wherein the knob (6) operates, and its vicinity, the vibration and the noises such as hitting and rubbing sounds are reduced.

In an embodiment of the present invention, a flat elastomeric ring which surrounds the knob hole (5) and which is disposed into the control panel (4) by being pressed between the front plate (2) and the rear plate (3) is used as the damping member (8).

In another embodiment of the present invention, the damping member (8) is produced from silicon and provides the front plate (2) and the rear plate (3) to be adhered.

In another embodiment of the present invention, the front plate (2) is produced from metal and the rear plate (3) from glass.

In another embodiment of the present invention, the thickness of the rear plate (3) is greater than the thickness of the front plate (2).

In yet another embodiment of the present invention, the front plate (2) and the rear plate (3) are produced from materials having different hardness values and the hardness value of the material the rear plate (3) is produced from is greater than the hardness value of the material the front plate (2) is produced from.

In the household appliance (1) of the present invention, the front plate (2) is produced from thin metal material and the rear plate (3) from thick glass material.

In the household appliance (1), the forces occurring due to the knob (6) hitting and rubbing against the bearing (7) during use are reduced by means of the damping member (8) disposed between the front plate (2) and the rear plate (3). By producing the front plate (2) and the rear plate (3) from materials having different thickness and hardness, the damping effect is increased and the knob (6) is provided to operate silently. The problem of the knob (6) operating loudly is resolved without applying any additional modifications on the knob (6) but only by disposing a thin damping member (8) between the plates (2, 3).

It is to be understood that the present invention is not limited by the embodiments disclosed above and a person skilled in the art can easily introduce different embodiments. These should be considered within the scope of the protection postulated by the claims of the present invention.

1. A household appliance (1) comprising a control panel (4) which has a front plate (2) and a rear plate (3) adjacent to each other placed one in front of the other, a knob hole (5) which is located on the control panel (4), a retractable and rotary knob (6) which moves inside the knob hole (5) and a bearing (7) which is disposed into the knob hole (5) and supports the knob (6) so that the knob (6) slidably move therein by surrounding the knob (6), characterized in that an elastic damping member (8) which is disposed between the front plate (2) and the rear plate (3) and which surrounds the knob hole (5).

2. The household appliance (1) as in claim 1, wherein the damping member (8) which is an elastomeric ring disposed into the control panel (4) by being pressed between the front plate (2) and the rear plate (3).

3. The household appliance (1) as in claim 1, wherein the damping member (8) which is produced from silicon and provides the front plate (2) and the rear plate (3) to be adhered.

4. The household appliance (1) as in claim 3, wherein the front plate (2) produced from metal and the rear plate (3) produced from glass.

5. The household appliance (1) as in claim 4, wherein the rear plate (3), the thickness of which is greater than the thickness of the front plate (2).

6. The household appliance (1) as in claim 5, wherein the rear plate (3), the hardness value of the material of which it is produced from is more than the hardness value of the material of which the front plate (2) is produced from.

7. The household appliance (1) as in claim 1, wherein the front plate (2) produced from metal and the rear plate (3) produced from glass.

8. The household appliance (1) as in claim 2, wherein the front plate (2) produced from metal and the rear plate (3) produced from glass.

9. The household appliance (1) as in claim 1, wherein the rear plate (3), the thickness of which is greater than the thickness of the front plate (2).

10. The household appliance (1) as in claim 2, wherein the rear plate (3), the thickness of which is greater than the thickness of the front plate (2).

11. The household appliance (1) as in claim 3, wherein the rear plate (3), the thickness of which is greater than the thickness of the front plate (2).

12. The household appliance (1) as in claim 1, wherein the rear plate (3), the hardness value of the material of which it is produced from is more than the hardness value of the material of which the front plate (2) is produced from.

13. The household appliance (1) as in claim 2, wherein the rear plate (3), the hardness value of the material of which it is produced from is more than the hardness value of the material of which the front plate (2) is produced from.

14. The household appliance (1) as in claim 3, wherein the rear plate (3), the hardness value of the material of which it is produced from is more than the hardness value of the material of which the front plate (2) is produced from.

15. The household appliance (1) as in claim 4, wherein the rear plate (3), the hardness value of the material of which it is produced from is more than the hardness value of the material of which the front plate (2) is produced from.
